(19) United States
(12) Patent Application Publication
(10) Pub. No.: US 2025/0335994 A1
(43) Pub. Date: Oct. 30, 2025

(54) DIGITAL ASSET ANALYZER

(71) Applicant: Emmanuel Coffy, Lawrence Harbor, NJ (US)

(72) Inventor: Emmanuel Coffy, Lawrence Harbor, NJ (US)

(21) Appl. No.: 18/613,044

(22) Filed: Mar. 21, 2024

(51) Int. Cl. G06Q 40/06; G06F 16/953; G06Q 50/18

(52) U.S. Cl. CPC G06Q 40/06; G06F 16/953; G06Q 50/184

(57) ABSTRACT

A method and system for analyzing digital assets are disclosed. The method includes receiving digital assets and using machine learning algorithms to automate the identification process of the received digital assets. The identified digital assets are then named based on the results of the machine learning algorithms. The system includes processors, memory, and machine learning algorithms stored in the memory and executable by the processors to automate the identification process of digital assets and name the identified digital assets. A non-transitory computer-readable medium storing instructions that cause the processors to perform the method is also disclosed.

### RELATED APPLICATIONS

This application claims priority from a United States Patent Application Nos. 63/213,087 filed Jun. 21, 2021, and 63/440,526 filed Jan. 23, 2023 entitled “Digital Data Analyzer”, which are incorporated herein by reference.

### FIELD OF INVENTION

Embodiments of the present disclosure relate generally to the field of Information and Communication Technology and more specifically to a digital asset analyzer for automation of naming a digital entity.

### BACKGROUND

A digital entrepreneur is someone who is engaged in the on-demand or sharing economy made possible by technology-enabled platforms. This new era is referred to as the fourth (4^{th}) industrial revolution and the great beneficiaries of this new trend are the providers of intellectual capital.

Being a digital entrepreneur who is engaged in e-Commerce using digital platforms, the marginal cost of producing each additional service (good) tends towards zero. As a result, it is necessary to leverage one's intellectual property (IP), which is a fuel to any enterprise.

### SUMMARY

According to an aspect of the present disclosure, an autonomous digital asset analyzer comprising: a domain name processing engine for retrieving and processing a domain related information; a trademark processing engine for retrieving and processing a trademark related information; a business name processing engine for generating at least three business names compatible with the domain name and trademark; and a payment processing engine for purchasing a domain name and registering a trademark upon selection of at least one of the generated business names, wherein all the processing engines are integrated together to form a front-end integrated search engine and suggests a compatible business name, domain name and trademark harmoniously.

In accordance with embodiments, a computer-implemented method is provided for managing and analyzing digital assets. The method involves receiving digital assets and using one or more machine learning algorithms to automate the identification process of these assets. The identified digital assets are then named based on the results of the machine learning algorithms.

In accordance with other embodiments, a digital asset management and analyzer system is provided. The system comprises one or more processors, a memory coupled to the processors, and one or more machine learning algorithms stored in the memory. These algorithms, executable by the processors, automate the identification process of digital assets and name the identified assets.

In yet other embodiments, a non-transitory computer-readable medium is provided that stores instructions. When executed by one or more processors, these instructions cause the processors to perform a method for analyzing and managing digital assets. This method involves receiving digital assets, using one or more machine learning algorithms to automate the identification process of the received assets, and naming the identified assets based on the results of the machine learning algorithms.

In further embodiments, a method for analyzing and managing digital assets is provided. This method involves receiving digital assets from one or more digital communication systems, using one or more machine learning algorithms to automate the identification process of the received assets, and naming the identified assets based on the results of the machine learning algorithms.

Several aspects are described below, with reference to diagrams. It should be understood that numerous specific details, relationships, and methods are set forth to provide a full understanding of the present disclosure. One who skilled in the relevant art, however, will readily recognize that the present disclosure can be practiced without one or more of the specific details, or with other methods, etc. In other instances, well-known structures or operations are not shown in detail to avoid obscuring the features of the present disclosure.

### BRIEF DESCRIPTION OF DRAWINGS

The teachings of the present invention can be readily understood by considering the following detailed description in conjunction with the accompanying drawings, in which:

FIG. 1 is a block diagram illustrating an exemplary communication system in which various aspects of the present disclosure may be seen;

FIG. 2 is a functional block diagram illustrating a digital asset analyzer in an embodiment of the present disclosure;

FIG. 3 is a flowchart illustrating the steps involved in the backend of the digital asset analyzer of the present disclosure;

FIG. 4 is a flowchart illustrating continuous data monitoring to recommend a digital asset name according to an embodiment of the present disclosure;

FIG. 5 illustrates, in a flowchart, operations for analyzing digital assets/entities using artificial intelligence in accordance with certain embodiments;

FIG. 6 illustrates, in a block diagram, a digital asset analyzer system utilizing artificial intelligence in accordance with certain embodiments;

FIG. 7 illustrates, in a flowchart, operations for analyzing digital entities using machine learning in accordance with certain embodiments; and

FIG. 8 illustrates, in a block diagram, a digital entity/asset analyzer system utilizing deep learning in accordance with certain embodiments.

### DETAILED DESCRIPTION OF THE PREFERRED EMBODIMENTS

The illustrative digital asset analyzer for naming digital entities described herein is not meant to be limiting. It may be readily understood that certain aspects of the disclosed digital asset analyzer can be arranged and combined in a variety of different configurations, all of which are contemplated herein.

For a digital entrepreneur, a business name, domain name and intellectual property such as trademarks, patents and the like are necessary to build intangible assets value of the enterprise. In order to build a good IP portfolio, one should have a good business name in the market place where customers rely on your business name as the genuine source of the goods/services of your business. In order to protect your business' name from counterfeit and duplicate products and/or services, a savvy and prudent entrepreneur trademark the business name and any associated slogan. Similarly, with the increase in e-Commerce and impact of the digital era, a domain name is a must to attract customers' attention and to gain their trust in your products and/or services.

It is, therefore, the best practice to maintain the same business name, domain name and trademark to stand out from the competitors from in and around counter parts of the world. However, in order to achieve this, there are a plurality of databases, which provide the business names, domain names and trademarks that are available for registration individually. For example, if a digital entrepreneur with a chosen business name wish to protect the domain name and trademark for the same name, s/he needs to perform a search in individual databases independently. This is time consuming and also if any of trademark or domain name is not available for the chosen business name, he/she must start the entire search process from beginning which makes it more complex and tedious process. Accordingly, there is a need to automate the process thereby harmonizing the configuration of business name, domain name and trademark.

Any computing device for example, a cellular telephone or a smartphone or any ordinary computing device having similar functionality may implement various embodiments described herein. In various embodiments, any internet enabled device such as personal digital assistant, laptop, desktop, electronic book, tablets, and the like that are capable of accessing internet may implement the various embodiments of the present disclosure. While computing devices are generally discussed within the context of the description, the use of any device having similar functionality is considered to be within the scope of the present embodiments.

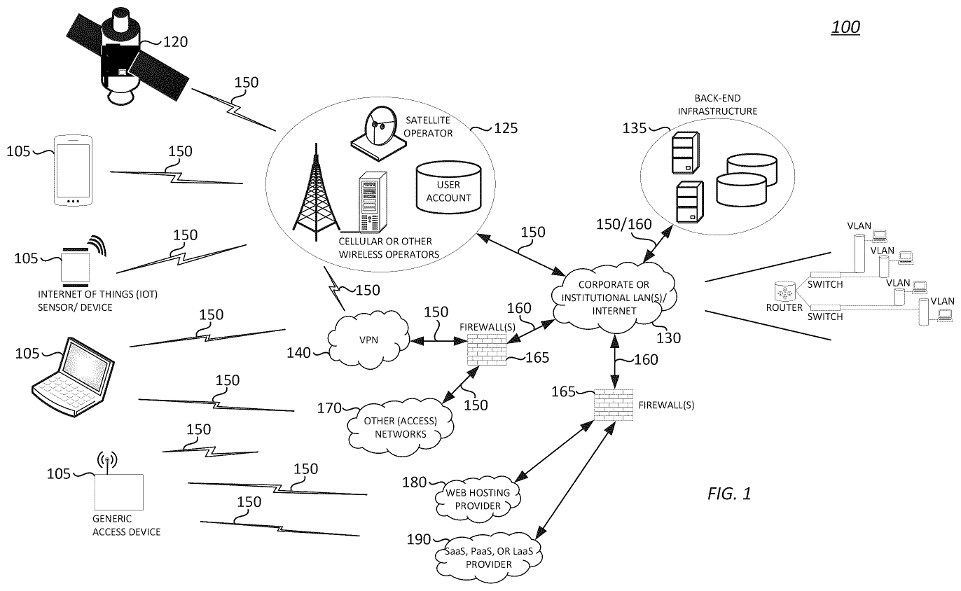

FIG. 1 is a block diagram illustrating an exemplary communication system in which various aspects of the present disclosure may be seen. As shown there, the communication system 100 comprises a user equipment/device 105, a satellite network 120, a cellular system 125, a plurality of networks (130, 140, 170, 180 and 190) and a back-end infrastructure 135. Each element of the communication system is described in further detail below.

The user device 105 is equipped with a multi-radio access technology with plurality of sensors that is able to access the internet. For example, the user device 105 comprises but not limited to a mobile device, smartphone, cellular telephone, personal digital assistant, Internet of Things (IoT) sensor or device, wireless hotspot or any internet enabled device such as a desktop computer, laptop computer, tablet computer, smart watch, smart remote control and any generic access device. The user device 105 further comprises a plurality of elements for example, a video camera, an audio sensor, a GPS sensor, and other sensors that may capture or assist in determining the operating and surrounding conditions. In one embodiment, the user device 105 interacts with networks 120, 125, 130, 135, 140, 170, 180 and 190 via a link (hereafter referred to as communication channel)150/160.

The communication channel 150/160 interlinks the plurality of networks 120, 125, 130, 135, 140, 170, 180 and 190 and also the systems such as cellular system, access network, backend infrastructure associated to server, host and web server, virtual private networks, web hosting providers, cloud services, hosting and the like. The communication channel 150/160 facilitates communication between the user device 105 and the plurality of networks 120, 125, 130, 135, 140, 170, 180 and 190 over a wired and/or wireless communication channel.

The wireless communication channel includes but not limited to GSM Network, CDMA network, etc., employing protocols defined in the respective standards. In one embodiment, the communication channel 150/160 facilitates the communication in accordance with the protocol specified in the LTE standard in general and LTE 4G, 5G, and 5GNR (fourth generation, fifth generation (fifth generation New Radio)) in particular.

In one embodiment, the communication channel 150/160 selects multiple modes and configurations for establishing communication between the user device 105 and the plurality of networks which may comprise a remote server. In another embodiment, the remote server may collect and stores the information received from the user device 105 and the plurality of networks 120, 125, 130, 135, 140, 170, 180 and 190 via the communication channel 150/160 in a database which may be further processed as per the requirement. The processed information from the remote server may be sent to the plurality of networks 120, 125, 130, 135, 140, 170, 180 and 190 and the user equipment (106) whenever requested.

In various embodiments of the present disclosure, the satellite network 120 comprises a geo-synchronous satellite system such as global positioning system (GPS). The satellite network 120 is configured to provide a communication signal via the communication channel 150 over a geographical region. A communication network that is deployed over the said geographical region allows the user device(s) 105 to send and receive signals from the plurality of networks 125, 130, 135, 140, 170, 180 and 190 and vice-a-versa.

In various embodiments, the cellular system 125 comprises a wireless infrastructure supporting cellular network functionality. In one embodiment, the cellular system 125 is a small area wireless system. In other embodiments, the cellular system 125 is a wide area wireless system. In various embodiments, the cellular system 125 supports mobile services within an LTE (Long Term Evolution) network or portions thereof, those skilled in the art and informed by the teachings herein may realize that the various embodiments are also applicable to wireless resources associated with other types of wireless networks (e.g., 5G networks, 4G networks, 3G networks, 2G networks, WiMAX, CDMA, GSM and the like), wireline networks or combinations of wireless and wireline networks. Thus, the network elements, links, connectors, sites and other objects representing mobile services may identify network elements associated with other types of wireless and wireline networks. In other embodiments, the use of any wireless system having similar functionality is considered to be within the scope of the present embodiments.

In various embodiments, the networks 130 and 170 comprises an access network. In one embodiment, the networks 140 is a virtual private network (VPN). In other embodiments, the networks 130 and 170 comprises any network having similar functionality and as such is considered to be within the scope of the present embodiments.

The back-end infrastructure 135 is generally referred to an infrastructure associated with a server or host and a web server. In other embodiments, the communication system 100 comprises additional, fewer or different modules for various applications. In one embodiment, the communication system 100 may also comprises and a virtual local area network (VLAN) that connects multiple devices and network nodes from different local area networks (LANs) into one logical network. Conventional components such as network interfaces, security functions, load balancers, failover servers, management and network operations consoles and the like are not shown for better explanation of the details of the reader and processor system for mobile devices.

In various embodiments, the network 180 comprises a web hosting provider that refers to the universe of hosting services, e.g., smaller hosting services, larger hosting services and host management. In various embodiments, the network 190 comprises SaaS (Software as a Service), PaaS (Platform as a Service) or IaaS (Infrastructure as a Service) provider that refers to cloud services, hosting and the like.

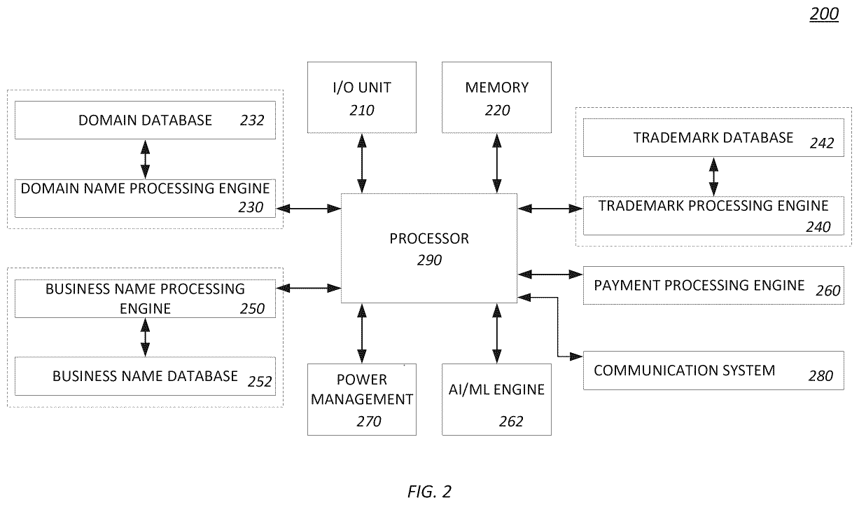

FIG. 2 is a functional block diagram illustrating a digital asset analyzer in an embodiment of the present disclosure. In various embodiments, the digital asset analyzer 200 is a system and/or device that enables any of its user to register a trademark and domain name upon selecting a given business name. In other embodiments, the digital asset analyzer 200 is a search engine tool with an integrated database for generating and/or suggesting a business name by checking the availability of trademark and domain name in their respective databases. The digital asset analyzer 200 also helps the user in registering a trademark and domain name compatible or in common with the user selected business name. In various other embodiments, the digital asset analyzer 200 is also deployed and/or accessed in any of the user device 105 interlinking at least two of the plurality of networks in the communication system 100.

The digital asset analyzer 200 comprises an I/O unit 210, a memory 220, a domain name processing engine 230, a trademark processing engine 240, a business name processing engine 250, a payment processing engine 260, an AI/ML engine 262, a power management unit 270, a communication system 280 and a processor 290.

The I/O unit 210 enables an exchange of information, data or commands to and from the digital asset analyzer 200 with external systems, modules and servers. The I/O unit 210 comprises, but is not limited to, a keyboard/pad, touch screen, USB ports, wireless ports, smart card interface, mouse and/or other control devices.

The memory unit 220 is configured to store data and instructions (e.g., one or more programs) for execution by the processor 290. The memory unit 220 provides a direct interface with other components in the digital asset analyzer 200 through the processor 290. The memory unit 220 comprises, but is not limited to, different types of Read Only Memory (ROM), Random Access Memory (RAM), external memory disks, removable disks, flash, caches and data cards.

The domain name processing engine 230 is configured to retrieve, analyse and process data related to a domain name from a domain database 232. In one embodiment, the domain name processing engine 230 checks for a domain name availability based on an input query and also helps a user to register the domain name on his/her opted name based on the availability. In another embodiment, the domain name processing engine 230 generates at least three domain names that are available for registration. In other embodiments, trusted sources comprising global web hosting providers, domain search tools, domain networks and plurality of databases are used in connection with the domain database 232 to confirm the available domain name for registration.

The trademark processing engine 240 is configured to retrieve, analyse and process data related to a trademark from a trademark database 242. In one embodiment, the trademark processing engine 240 performs a search and retrieve operation in trademark registries and/or agencies that are officially maintaining the trademark related information throughout the world based on the input query. For example, the input query may be searched in the United States Patent and Trademark Office (USPTO), the European Patent Office (EPO), the Office of the Patents, Designs and Trade Marks (CGPDTM), Intellectual Property Office of Singapore (IPOS), the China National Intellectual Property Administration (CNIPA) etc., and retrieves information that is similar or related to the input query.

In other embodiments, the trademark processing engine 240 is used to check the availability of a trademark to get it registered in a specific country or throughout the world (in multiple countries) and files a trademark application if the trademark is available upon the inputs and payment provided for the registration. In case of limited or unavailability of a trademark for the input query, the trademark processing engine 240 suggests at least three different trademark names based on the input query that are able to get registered in a selected country.

The business name processing engine 250 is configured to retrieve, analyse and process data related to a business name from a business name database 252. The business name processing engine works in coordination with the domain name processing engine (230) and the trademark processing engine (240) to generate/suggest a stand-alone business name in common with trademark and domain name. In case of a new business, the business name processing engine 250 suggests at least three business names compatible with the available trademark and domain names for registration using the domain name processing engine 230 and the trademark processing engine 240.

In various embodiments of the present disclosure, the domain name processing engine 230, the trademark processing engine 240 and the business name processing engine 250 are integrated together to form a single integrated search engine on the front end that works collectively based on the input query to suggest unique business names, domain names and trademarks harmoniously. In other embodiments, the integrated search engine comprises an integrated database by integrating the domain database 232, the trademark database 242 and the business name database. In yet another embodiment, the integrated database may be obtained by integrating at least two of the existing databases and plurality of databases may be integrated for various purposes. In another example, for an existing business name, the integrated search engine suggests a suitable domain name and trademark available for registration that too in a harmonious nature i.e., similar to that of the existing business name.

The payment processing engine 260 is configured to compute and process a payment upon selection of a suggested name and proceed for registration of respective domain or trademark. In an embodiment, the payment processing engine 260 stores confidential credit card and/or personal payment details in a private and secure database enabling a secure communication with a vendor or merchant's payment gateways. It helps to communicate with other devices and systems to promote business, products and process sales or transactions. In another embodiment, the payment processing engine comprises a registration module for registering a trademark and purchasing a domain name compatible with the business name. The registration module comprises a plurality of application programming interfaces (APIs) for filing an application form in the domain name processing engine 230 and the trademark processing engine 240 to obtain protection over a selected domain name and trademark.

In yet another embodiment, at least one of an individual and/or integrated module, application programming interfaces (APIs) are employed in the payment processing engine 260 for payment processing and registration of the domain name and/or trademark. For example, if a domain name and a trademark is selected for registration in the front-end integrated search engine of the present disclosure, the payment processing engine 260 computes the amount required for filing the application and upon receiving the payment, it redirects to the individual and/or integrated module and application programming interfaces (APIs) that prepare and file a new application with respective authorities with further inputs provided by the user.

The AI/ML (Artificial Intelligence/Machine Learning) engine 262 is configured to process personalised data traffic over a network for offering personalized customer services and place ads that users pay most attention to them. The AI/ML engine 262 helps in mimicking human cognitive functions like perception, learning and problem solving by employing various elements such as supervised, unsupervised and reinforcement learning algorithms and deep learning algorithms.

In various embodiments of the present disclosure, the AI/ML engine 262 gain insight into customer behaviour to enhance customer experiences and personalized offerings of the digital asset analyzer 200. In other embodiments, the AI/ML engine 262 employs a training and predictive model to generate/suggest a stand-alone business name compatible with available trademark and domain name. In other embodiments, the AI/ML engine 262 takes out relevant business insights from large amounts of data gathered from several sources. These data insights allow the digital asset analyzer 200 to provide a better user experience and to identify the end users who are likely to become loyal customers of the digital asset analyzer 200.

The power management unit 270 powers the digital asset analyzer 200 for a desired operation. The power management unit 270 may comprise, for example, batteries, circuitry, integrated circuits and other functional modules to manage and distribute power to various components i.e., 210 through 290 of the digital asset analyzer 200, according to power requirements of the respective components.

The communication system 280 is configured to establish communication between the digital asset analyzer 200 and external system(s)/device(s)/server(s) through one or more wired and/or wireless communication channels. In one embodiment, the communication system 280 comprises functional components that enable the digital asset analyzer 200 to transmit and receive data according to one or more of communication standards such as, but not limited to, GSM, CDMA, GPRS, Wi-Fi, LAN, and Bluetooth.

The processor 290 is configured to execute instructions to perform various mathematical and control operations. The processor 290 comprises one or more processors or processor cores operating in conjunction to execute multiple instructions sequentially or simultaneously. The processor 290 comprises processors or cores customized to efficiently perform specific tasks, such as one or more Digital Signal Processing (DSP) cores, math coprocessors etc. In one embodiment, the processor 290 is configured to perform operations related to components i.e., 210 through 280 of the digital asset analyzer 200 by executing a respective set of instructions (programs) stored in, for example, the memory unit 220. Thus, the processor 290 lends processing power to the components i.e., 210 through 280 and operates as part of the overall system.

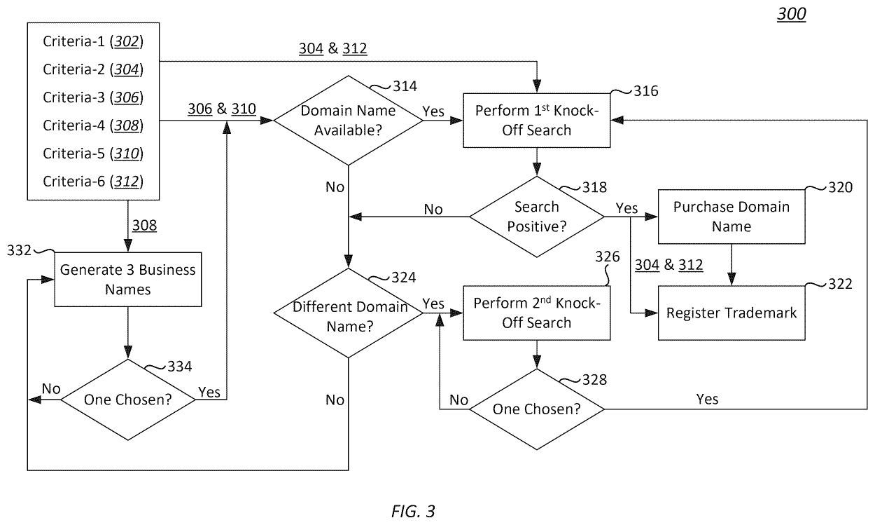

FIG. 3 is a flowchart 300 illustrating the steps involved in the backend of the digital asset analyzer of the present disclosure. The front-end of the digital asset analyzer comprises the single integrated search engine interconnecting the domain name processing engine 230, the trademark processing engine 240 and the business name processing engine 250. The manner in which the integrated search engine of the digital asset analyzer works in suggesting a business name, domain name and trademark is described in detail in the following embodiments.

The backend processing of the digital asset analyzer starts with a set of criteria chosen by the user. This set of criteria assists the digital asset analyzer to determine the actual requirements of the user which further helps in suggesting a business name, domain name and trademark. In an exemplary embodiment, a set of six criteria are provided to the search engine from which the user must fall into at least one of the said six criteria.

These set of criteria categorise the user of the digital asset analyzer of the present disclosure into the said six categories i.e., 302 through 312 based on user inputs. In 302, a digital entrepreneur who has an existing business with a domain name and trademark forms criteria-1. In 304, the digital entrepreneur who has an existing business with a domain name but no trademark forms criteria-2. In 306, the digital entrepreneur who has an existing business with a trademark but no domain name forms criteria-3. In 308, the digital entrepreneur who is planning a new business with no business name, domain name or trademark constitutes criteria-4. In 310, the digital entrepreneur who is planning a new business with a business name and trademark but no domain name constitutes criteria-5. In 312, the digital entrepreneur who is planning a new business with a business name and domain name but no trademark constitutes criteria-6.

In criteria-1, the user is directed to choose a list of authorised and/or registered asset managers who analyses the existing business name, domain name and trademark together to evaluate the intangible asset value. For those falling in this category 302 need not to go through the steps in the flowchart 300 unless they are looking for a new domain name and/or trademark.

In criteria-2 and criteria-6 i.e., 304 & 312, a first knock-out search is performed in step 316 for the domain name to determine if the domain name should be considered for trademark. In criteria-3 and criteria-5 i.e., 306 & 310, the digital asset analyzer checks for the availability of the domain name in step 314. If the domain name is available for registration, it proceeds to step 316 else to step 324. In step 316, the first knock-off search is performed by sending an input query by the user to the domain name processing engine 230, the trademark processing engine 240 and the business name processing engine 250 of the digital asset analyzer in order to obtain a compatible output resulting in a harmonious domain name, business name and trademark.

If the output from the first knock-off search is positive in step 318 i.e., the available domain name and trademark are compatible with the business name, it proceeds to step 320 and/or step 322, else to step 324. In step 320, the available domain name is purchased from the authorised and trusted domain name service providers with best offer price available in the market in real-time. Once the domain name is protected by purchasing it in step 320, it will go to step 322. In step 322, the trademark compatible with the domain name and the business name is protected by registering it in the trademark registry maintained by the authorised trademark office in respective jurisdiction.

In criteria-4 308, it goes to step 332. In step 332, at least three business names are suggested by collecting information from the user with respect to the nature and scale of business through a set of questionnaires pre-programmed in the digital data analyzer. In an embodiment, the set of questionnaires may vary for each individual based on the inputs provided by the user and the set of questionnaires may be amended or revised automatically by employing an artificial intelligence technology through the AI/ML engine. In step 334, if any one of the suggested three business names is chosen by the user, it proceeds to step 314, else to step 332. In step 314, if the domain name is not available after performing the domain availability check, it proceeds to step 324.

In step 324, the user is provided with an option either to proceed with a different domain name or not in case of unavailability of a specific domain name in the step 314. If the user opts to proceed with a different domain name in step 324, it proceeds to step 326 else to step 332.

In step 326, a second knock-off search is performed to check the availability of the different domain names that are similar or close to the specific domain name used in the step 314. In one embodiment, at least three different domain names are suggested to the user for purchasing one at a best available price. If any of the suggested different domain name is chosen by the user in step 328, it proceeds to the step 316 else to step 326. In step 316, the first knock-off search is performed to determine if the different domain name should be considered for trademark registration.

Thus, the back-end operations are performed in the digital asset analyzer of the present disclosure to suggest the same business name, domain name and trademark for different criteria i.e., 302 through 312.

In an exemplary embodiment, the set of criteria i.e., 302 through 312 are presented to the user to choose any of his/her choice. In such cases, the execution of various steps in the FIG. 3 are performed simultaneously or concurrently also known as multitasking. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally or logically, are understood to be implemented by computer programs or equivalent electrical circuits, microcode, and the like. Furthermore, it is proven convenient at times to refer to these arrangements of operations as modules. The described operations and their associated modules may be embodied in a software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium comprising a computer program code, which may be executed by a computer processor for performing any or all of the steps, operations, or processes described.

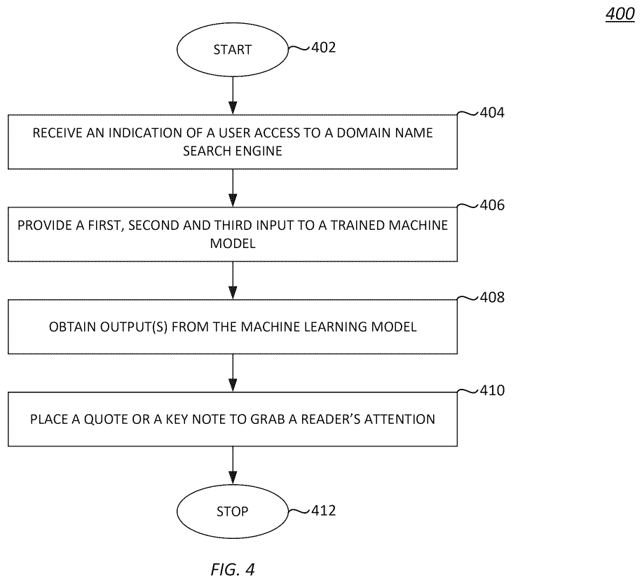

FIG. 4 is a flowchart illustrating continuous data monitoring to recommend a digital asset name according to an embodiment of the present disclosure. The flowchart 400 starts at 402. In step 404, the digital asset analyzer of the present disclosure receives an indication of a user accessing a domain name search engine. For example, the software module i.e., the digital asset analyzer of the present disclosure receives information through a plurality of Application Programming Interface (APIs) and/or cache and cookies in a user equipment connected over a network of any user searches in a search engine or a domain database for availability of a domain name.

In step 406, a first, second and third inputs are provided to a trained machine learning model deployed within the digital asset analyzer of the present disclosure. In an embodiment, the first input comprises contextual information associated with the user access. Contextual information is data that provides context to a person, entity, or event. It can also be defined as information related to the circumstances in which an event occurred. For example, the name or address of the host on which the event occurred, or the host that caused the event to occur. The second input comprises user information associated with the user access. User information is information transferred across the functional interface between a source user and a telecommunications system for delivery to a destination user. Specifically, in telecommunications systems, user information includes user overhead information, Names, Domain names, Addresses, Login credentials, Telephone and device numbers, Message content, Data files and the like. The third input comprises data items used for searching the digital asset analyzer of the present disclosure. A data item is a characteristic or attribute of a data unit that is measured or counted. Data items can be single items, called scalars, or a collection of items, called data aggregates. Examples of data items include height, business name, trademark, country of birth, or income and the like. Data items are also known as variables because the characteristic may vary between data units and may vary over time. Furthermore, a data item describes a specific state of an object at a specific time. Data items are identified by the object, property, and time. The value of a data item is a function of the object, property, and time. Values are typically represented by symbols like numbers or text. These first, second and third inputs are archived and live streamed concurrent with the user access that are currently being consumed by users of a first plurality of user clusters on the search engine platform.

In step 408, the output(s) from the machine learning model are obtained which identifies a plurality of live-stream data items and a level of confidence the user is to consume a respective live-stream data item of the plurality of live-stream data items. A confidence level (CL) is a statistical measure that estimates the percentage of test results that are expected to fall within a specified range. It can also be defined as the likelihood expressed as a percentage or probability, that a specified interval will contain the population parameter. A confidence level is the long-term success rate of a method. It refers to how often a confidence interval will capture the parameter of interest. A confidence interval gives a range of plausible values for the parameter of interest. Factors that affect confidence intervals include: Population size, Sample Size, Percentage. A 0% confidence level means you have no faith at all that if you repeated the survey that you would get the same results.

In step 410, the reader's i.e., user's attention is grabbed by placing a quote or a key note from the outputs of step 408 to emphasize a key point with respect to the determined initial access to the domain name search engine. The keynote or quote generated in step 410 may be placed anywhere on a page by dragging to a desired location. The flowchart ends in step 412.

The steps 402 through 412 imitate an artificial intelligence-based data mining, collecting and scrubbing by continuous monitoring of traffic on the network. The keywords used in a search from a specific user equipment on the network is determined and then the machine learning model presents a quote or keynote on the screen of the user equipment linked with the same IP address at a desired location on a page. For example, if an individual searched for a domain name in a database using a user equipment in a network, the digital asset analyzer of the present disclosure grabs the attention of the individual by placing an advertisement like note with domain name suggestions for his business.

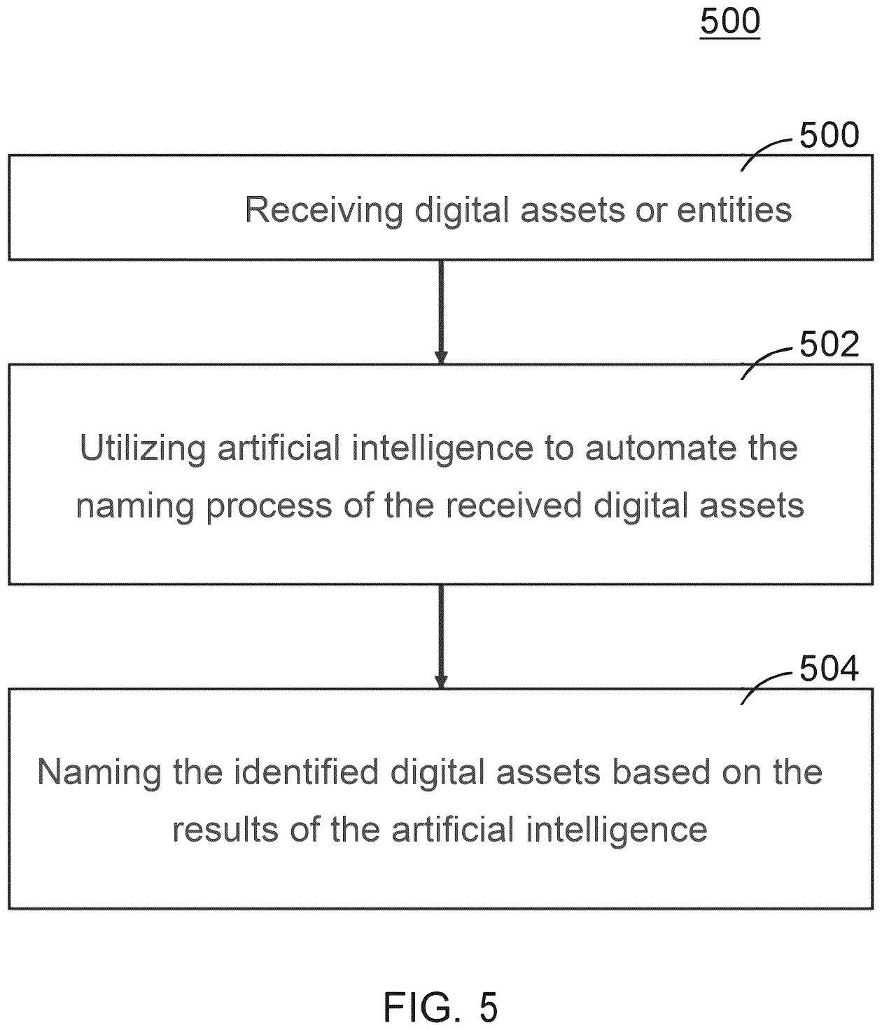

FIG. 5 illustrates, in a flowchart, operations for analyzing digital assets/entities using artificial intelligence in accordance with certain embodiments.

In step 500, digital files, which are one form of digital entities, are received. This could be accomplished by a Data Classification System, which is an alternative for the Digital Asset Analyzer. In one embodiment, the Data Classification System has a built-in feature that allows it to connect to various sources like servers, cloud storage, or user devices to receive the digital files. The files could be in various formats such as text, image, audio, or video. The output of this step comprise the digital files ready for the next step.

In step 502, the received digital files are processed using machine learning algorithms, which is a form of artificial intelligence. This could be accomplished by an AI-based Naming Tool, another alternative for the Digital Asset Analyzer. In one embodiment, the AI-based Naming Tool has a feature that allows it to analyze the content of the digital files using machine learning algorithms. These algorithms are trained on a dataset of previously identified and named digital files to learn the patterns and rules for naming. The input for this step is the digital files from the previous step and the output is the identified digital files ready for naming.

In step 504, the identified digital files are named based on the results of the machine learning algorithms. This could be accomplished by an Automated File Renamer, yet another alternative for the Digital Asset Analyzer. In one embodiment, the Automated File Renamer has a feature that allows it to generate names for the digital files based on the results of the machine learning algorithms. In one embodiment, the names are generated in a way that reflects the content of the digital files and follows a certain naming convention for easy retrieval in the future. The input for this step is the identified digital files from the previous step and the output is the named digital files.

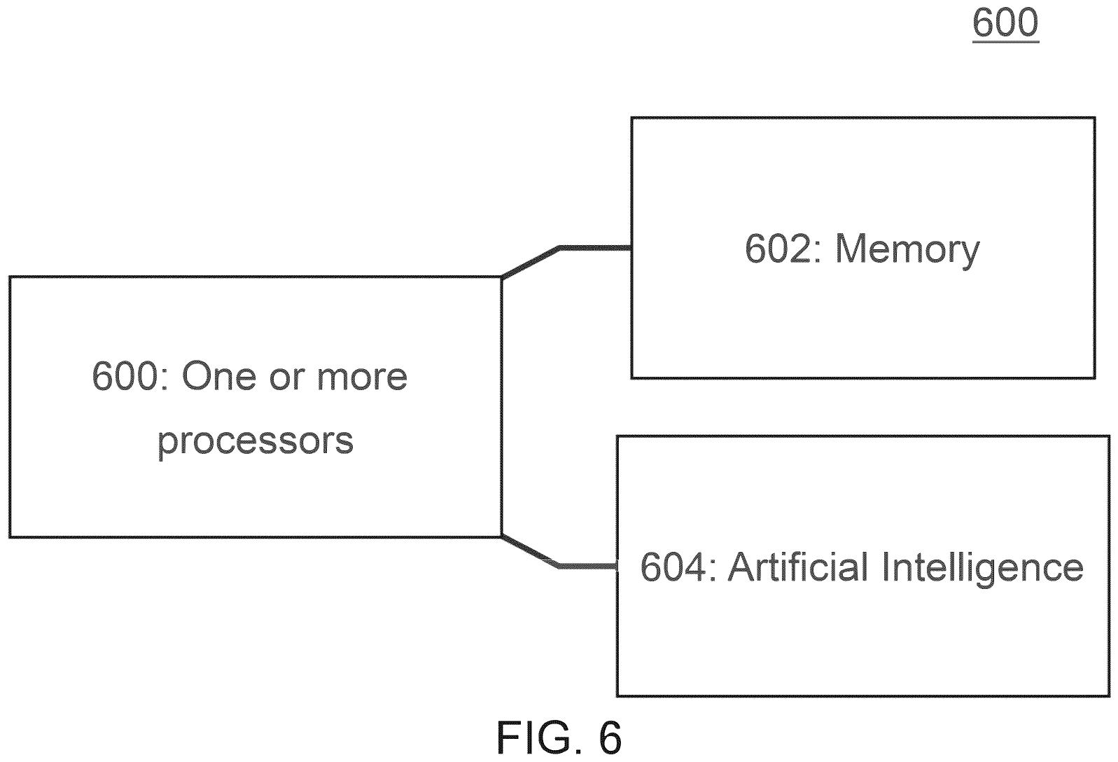

FIG. 6 illustrates, in a block diagram, a digital asset analyzer system utilizing artificial intelligence in accordance with certain embodiments.

The digital asset analyzer system (600) is a key component in automating the identification process of digital assets. This system can be alternatively referred to as a Data Classification System, File Organizer Software, or a Content Management System. The system receives digital files, documents, or images (collectively referred to as digital assets) as input and processes them using machine learning algorithms. The output of this system is the named digital assets, which have been identified and named based on the results of the machine learning algorithms. The memory (602) is another essential component of the system. It can be seen as a storage unit for the machine learning algorithms, which are a form of Artificial Intelligence. The memory receives the machine learning algorithms as input and stores them for execution by the processors. The output from the memory is the same machine learning algorithms, now ready to be executed by the processors. The Artificial Intelligence (604), which can also be referred to as Machine Learning, Deep Learning, or Neural Networks, is the component that enables the automation of the naming process. It receives the digital assets as input and processes them using the machine teaming algorithms. The output of this component is the named digital assets. The Artificial Intelligence is capable of learning and improving the naming process over time, which means it can adapt and improve its performance with each new set of digital assets it processes. In summary, the digital asset analyzer system (600) receives digital assets, processes them using the machine learning algorithms stored in the memory (602), and outputs the named digital assets. The Artificial Intelligence (604) plays a crucial role in this process by automating the naming process and improving it over time. The system is capable of receiving digital assets from various sources, processing them, and outputting the named digital assets, making it a versatile and efficient tool for managing and naming digital assets or entities.

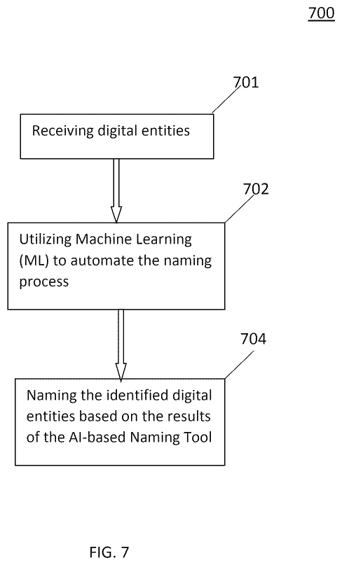

FIG. 7 illustrates, in a flowchart, operations for analyzing digital entities using machine learning in accordance with certain embodiments.

The process begins at step 701 with the receipt of digital assets or entities. These entities can be any form of digital content such as files, documents, images, videos, audios, data, records, or resources. The receipt of these entities can be through various means such as downloading from the Internet. In other embodiments, the receipt of these entities is achieved through transferring from another device. In yet other embodiments, the receipt of these entities is generating within the system.

Once the digital assets or entities are received, in step 702 the system utilizes machine learning to automate the naming process. Machine learning, a subset of artificial intelligence, is a method of data analysis that automates analytical model building. It is based on the idea that systems can learn from data, identify patterns and make decisions with minimal human intervention. In this context, the machine learning algorithm is trained to analyze the digital entities and generate appropriate names based on the content, type, source, or any other relevant factors of the entities. The training of the machine learning algorithm can be done using a dataset of previously identified and named digital entities, allowing the system to learn and improve the naming process over time.

The final step 704 is the naming of the identified digital entities based on the results of the AI-based Naming Tool. The AI-based Naming Tool is a software application that uses artificial intelligence to generate names for digital entities. The tool analyzes the digital entities, applies the learned naming patterns, and generates names that accurately represent the content, type, source, or other relevant factors of the entities. The output of this step is the digital entities with its newly assigned names, ready for further processing, storage, or use.

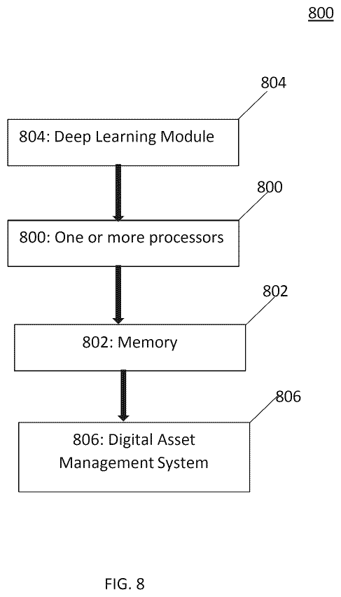

FIG. 8 illustrates, in a block diagram, a digital entity/asset analyzer system utilizing deep learning in accordance with certain embodiments.

The digital entity analyzer system comprises of several components that work together to manage and analyze digital entities. The main component is the “One or more processors” (Component 800). These processors are the heart of the system, executing instructions and processing data. They receive instructions from the “Deep Learning Module” (Component 804), which is a specialized software application that uses artificial intelligence to analyze digital entities and generate appropriate names based on the content, type, source, or any other relevant factors of the entities. The processors then process this data and pass it on to the “Memory” (Component 802). The “Memory” (Component 802) is a storage component that holds the processed data from the processors. It receives this data, stores it, and then provides it to the “Digital Asset Analyzer System” (Component 806) when needed. The memory is crucial for the system as it allows for the temporary storage of data, enabling the system to handle multiple digital entities simultaneously and efficiently. The “Digital Asset Analyzer System” (Component 806) is the final component of the system. It receives the stored data from the memory and uses it to name the digital entities. The Digital Asset Analyzer System is a software application that manages digital content. It organizes, categorizes, and locates digital assets and manages digital rights and permissions. It uses the data provided by the memory to assign appropriate names to the digital entities, thus completing the process of managing digital entities.

In one embodiment, the domain name processing engine, the business name processing engine, the payment processing engine, and the trademark processing engine are incorporated within the AI/ML engine.

In other embodiment, all of the processing engines are incorporated within the AI/ML engine.

While various embodiments of the present disclosure have been described above, it should be understood that they have been presented by way of example only, and not limitation. Thus, the breadth and scope of the present disclosure should not be limited by any of the above-discussed embodiments but should be defined only in accordance with the following claims and their equivalents.

I/We claim:

1. A digital asset analyzer comprising:
a domain name processing engine for retrieving and processing a domain related information;
a trademark processing engine for retrieving and processing a trademark related information;
a business name processing engine for generating at least three business names compatible with the domain name and trademark;
a payment processing engine for purchasing a domain name and registering a trademark upon selection of at least one of the generated business names;
an artificial intelligence (AI)/machine learning (ML) engine;
one or more processors coupled to the processing engines;
a memory coupled to the one or more processors;
one or more machine learning algorithms stored in the memory and executable by the AI/ML engines to automate the identification process of unique digital assets and name the identified digital assets,
wherein the processing engines are integrated together to form a front-end integrated search engine.

2. The digital asset analyzer as claimed in claim 1, wherein the front-end integrated search engine processes an input query from a user only after categorising the user into at least one of pre-defined scenarios.

3. The digital asset analyzer as claimed in claim 2, wherein the pre-defined scenarios comprise at least one of a digital entrepreneur with existing business, domain name and trademark; existing business with domain name but no trademark; existing business with trademark but no domain name; new business without business name, domain name and trademark; new business with business name, trademark but no domain name; and new business with business name, domain name but no trademark.

4. The digital asset analyzer as claimed in claim 3, wherein the payment processing engine further comprises a registration module to perform registration process of a selected trademark and domain name.

5. The digital asset analyzer as claimed in claim 4, wherein the business name compatible domain name and trademark are obtained and registered by using the single front-end integrated search engine of the digital asset analyzer.

6. The digital asset analyzer as claimed in claim 5, wherein available business name, domain name and trademark are searched in different databases of the processing engines and collective information is used to generate new name suggestions.

7. A non-transitory computer-readable medium storing instructions that, when executed by one or more processors, cause the one or more processors to perform a method for analyzing digital assets, the method comprising:
receiving one or more digital assets names;
utilizing one or more machine learning algorithms to automate the identification process of the received digital assets;
naming the identified digital assets based on the results of the machine learning algorithms,
determining, based on the results of the machine learning algorithms, an identifier for each of the one or more digital assets based on a set of predefined rules;
assigning the determined identifier to each of the one or more digital assets names; and
suggesting one or more unique digital asset compatible names.

8. The method of claim 7, wherein the set of predefined rules includes rules based on the type of the digital assets.

9. The method of claim 7, wherein the set of predefined rules includes rules based on the content of the digital assets.

10. The method of claim 7, wherein the set of predefined rules includes rules based on the source of the digital assets.

11. The method of claim 7, wherein the set of predefined rules includes rules based on the date and time of creation of the digital assets.

12. The method of claim 7, further comprising:
storing the one or more digital assets along with their assigned identifiers in a database.

13. The method of claim 12, further comprising:
retrieving a digital asset from the database based on its assigned identifier.

14. The method of claim 7, further comprising:
updating the identifier of a digital asset based on changes in the set of predefined rules.

15. The method of claim 7, further comprising:
providing a user interface for a user to manually assign or change the identifier of a digital asset.

16. The method of claim 7, wherein the machine learning algorithms are trained on a dataset of previously identified and named digital assets.

17. The method of claim 7, wherein the machine learning algorithms are capable of learning and improving the identification and naming process over time.

18. The method of claim 7, wherein the machine learning algorithms utilize natural language processing techniques to name the identified digital assets.

19. The method of claim 7, further comprising storing the named digital assets in a database for future reference.
